(19) United States
(12) Patent Application Publication
(10) Pub. No.: US 2008/0008144 A1
(43) Pub. Date: Jan. 10, 2008

(54) Mobile video system for vehicles

(75) Inventors: Kuo-Rong Chen, Panchiao City (TW); Chun-Chung Lee, Taipei (TW); Ming-Wen Yang, Sinjhuang City (TW)

Correspondence Address: BACON & THOMAS, PLLC, 625 SLATERS LANE, FOURTH FLOOR, ALEXANDRIA, VA, 22314, US

(73) Assignee: Sin Etke Technology Co., Ltd., Taipei City (TW)

(21) Appl. No.: 11/515,035

(22) Filed: Sep. 5, 2006

(30) Foreign Application Priority Data
Jul. 6, 2006 (TW) 095124627

(51) Int. Cl. H04Q 7/24

(52) U.S. Cl. 370/338; 370/401

(57) ABSTRACT

A mobile video system for vehicles, which includes a wireless receiver, a decoder, a sound device, a display and a controller. The wireless receiver receives a wireless video signal and demodulates the video signal to thereby produce a digital transport stream. The decoder receives and decodes the digital transport stream to thereby produce a video data stream. The controller performs initialization and operating mode settings on the wireless receiver, the decoder, the sound device and the display, and drives the decoder to decode the digital transport stream to thereby produce the video data stream. When the wireless receiver is a detachable wireless receiver, the decoder, the sound device, the display and the controller are integrated into an embedded system.

### BACKGROUND OF THE INVENTION

1. Field of the Invention

The present invention relates to a mobile video system and, more particularly, to a mobile video system capable of playing a wireless video signal in wireless transmission.

2. Description of Related Art

In the past, various vehicles could only provide the function of music for people to listen to. However, with the increasingly improved technologies, the vehicles can provide not only such music but also video. FIG. 1 is a block diagram of a typical on-vehicle mobile video system 100. As shown in FIG. 1, the system 100 includes a video compact disk (VCD) extractor 110, a decoder 120, a sound device 150, a display 130 and a controller 140.

The VCD extractor 110 extracts an MPEG1 video data stream recorded in the VCD. The decoder 120 is connected to the VCD extractor 110 in order to receive the MPEG1 video data stream and decode it based on the MPEG1 format. Thus, a video data stream is produced. The sound device 150 is connected to the decoder 120 in order to receive the sound signal corresponding to the video data stream for playing. The display 130 is connected to the decoder 120 in order to receive the image signal corresponding to the video data stream for playing. Accordingly, the on-vehicle music and video are provided. However, the limited space in a vehicle, such as a car, cannot accommodate many VCDs so that only few programs can be selected. In addition, the on-vehicle mobile video system 100 cannot play a real-time video program.

Therefore, it is desirable to provide an improved device to mitigate and/or obviate the aforementioned problems.

### SUMMARY OF THE INVENTION

An object of the present invention is to provide an on-vehicle mobile video system, which can play a real-time video program.

Another object of the present invention is to provide a mobile video system for vehicles, which can overcome the problem that only few programs can be selected due to the limited space in a car.

To achieve the objects, there is provided a mobile video system. The mobile video system includes a wireless receiver, a decoder, a sound device, a display and a controller. The wireless receiver receives a wireless video signal in wireless transmission and demodulates the wireless video signal to thereby produce a digital transport stream. The decoder is connected to the wireless receiver in order to receive and decode the digital transport stream to thereby produce a video data stream. The sound device is connected to the decoder in order to receive a sound signal corresponding to the video data stream for playing. The display is connected to the decoder in order to receive an image signal corresponding to the video data stream for playing. The controller is electrically connected to the wireless receiver, the decoder, the sound device and the display in order to perform initialization and operating mode settings on the wireless receiver, the decoder, the sound device and the display, and drive the decoder to decode the digital transport stream to thereby produce the video data stream.

Other objects, advantages, and novel features of the invention will become more apparent from the following detailed description when taken in conjunction with the accompanying drawings.

### BRIEF DESCRIPTION OF THE DRAWINGS

FIG. 1 is a block diagram of a conventional mobile video system;

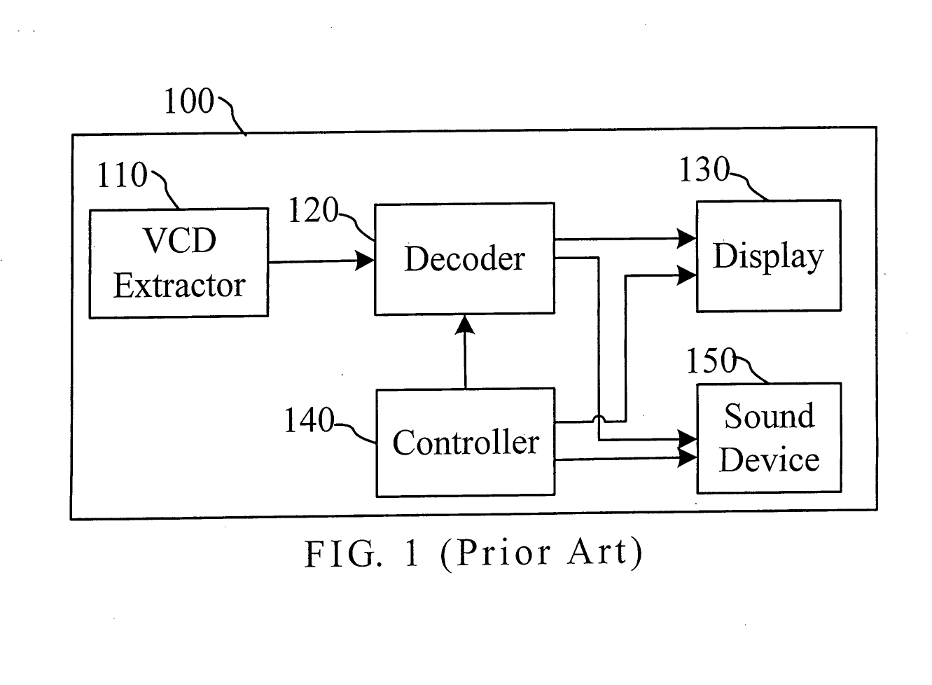

FIG. 2 is a block diagram of a mobile video system in accordance with the invention;

FIG. 3 is a block diagram of a mobile video system in accordance with another embodiment of the invention; and

FIG. 4 is a block diagram of a mobile video system in accordance with a further embodiment of the invention.

### DETAILED DESCRIPTION OF THE PREFERRED EMBODIMENT

The mobile video system uses a wireless receiver to receive a wireless video signal in wireless transmission and demodulate the wireless video signal to thereby produce a digital transport stream. Accordingly, a real-time video program can be played.

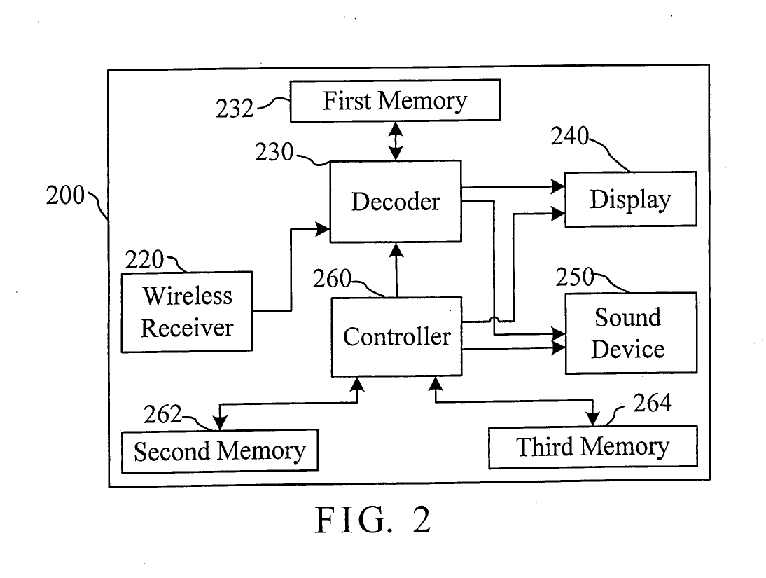

FIG. 2 is a block diagram of the mobile video system 200 in accordance with the invention. As shown in FIG. 2, the system 200 includes a wireless receiver 220, a decoder 230, a sound device 250, a display 240, a controller 260, a first memory 232, a second memory 262 and a third memory 264.

The wireless receiver 220 receives a wireless video signal and demodulates the wireless video signal to thereby produce a digital transport stream. In this embodiment, the wireless receiver 220 can be a digital television (DTV) tuner to receive a wireless DTV signal in wireless transmission and demodulate the wireless DTV signal to thereby produce the digital transport stream. The DTV tuner first performs demodulation on a radio frequency (RF) TV signal to thereby obtain an intermediate frequency (IF) signal, and then demodulates the IF signal to thereby obtain an MPEG1, MPEG2, MPEG4 or H.264 digital transport stream. The DTV tuner performs a coded orthogonal frequency division multiplexing (COFDM), binary phase shift keying (BPSK), or quadrature phase shift keying (QPSK) modulation.

The decoder 230 is connected to the wireless receiver 220 in order to receive and decode the digital transport stream to thereby produce a video data stream. The decoder 230 can be a digital signal processor (DSP) to respectively decode the MPEG1, MPEG2, MPEG4 and H.264 video data streams or the digital transport stream. The first memory 232 is connected to the decoder 230 in order to temporarily store the temporary data produced in decoding. The first memory 232 is preferred to be a double date rate synchronous dynamic random access memory (DDR SDRAM).

The sound device 250 is connected to the decoder 250 in order to receive a sound signal corresponding to the video data stream for decoding and playing. The display 240 is connected to the decoder 230 in order to receive an image signal corresponding to the video data stream for playing.

The controller 260 is electrically connected to the wireless receiver 220, the decoder 230, the sound device 250 and the display 240. Accordingly, the controller 260 can perform the initialization and operating mode settings on the wireless receiver 220, the decoder 230, the sound device 250 and the display 240.

The second memory 262 is connected to the controller 260 in order to store a bootloader and an embedded operating system (OS). The second memory 262 is preferred to be a NOR-type flash memory. The embedded OS can be a Window Mobile embedded OS provided by Microsoft Corp, or an RTLimux embedded OS.

The third memory 264 is connected to the controller 260 in order to provide a temporary storing location for the controller 260 on performing the embedded OS. The third memory 264 is preferred to be the DDR SDRAM. The controller 260 drives the decoder 230 to decode the digital transport stream to thereby produce the video data stream.

The controller 260 and the decoder 230 can be integrated into a same chip. The first memory 232 and the third memory 264 can be integrated into a same chip.

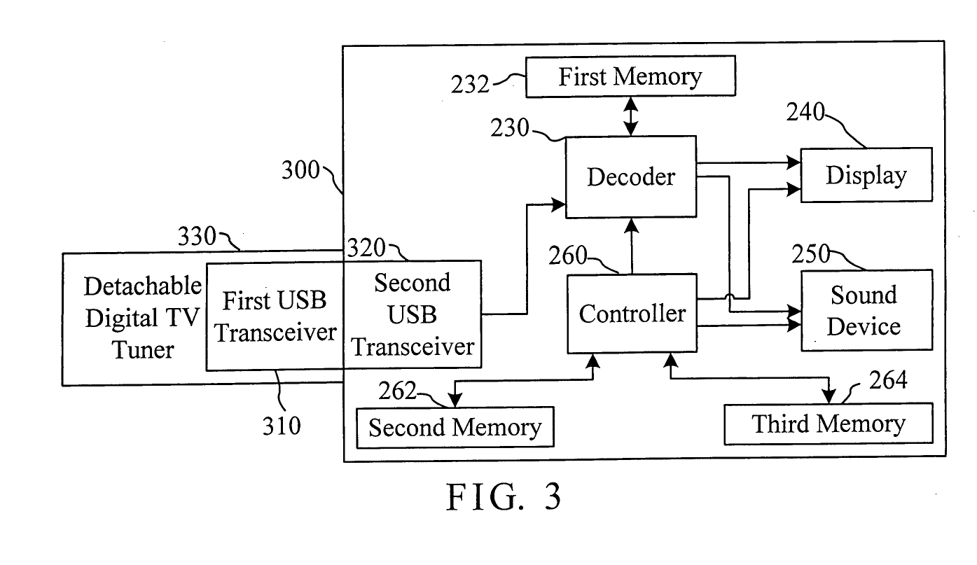

FIG. 3 is a block diagram of the mobile video system 300 in accordance with another embodiment of the invention. The system 300 is as same as the system 200 of FIG. 2 except a detachable wireless receiver 330. In this embodiment, the wireless receiver 330 is a detachable DTV tuner to receive the wireless DTV signal in wireless transmission and tune the wireless DTV signal to thereby produce the digital transport stream.

Since the wireless receiver 330 is the detachable wireless receiver, the decoder 230, the sound device 250, the display 240 and the controller 260 are integrated into an embedded system.

The detachable DTV tuner 330 includes a first universal serial bus (USB) transceiver 310 to convert the digital transport stream into a USB digital transport stream to output. In addition, the mobile video system 300 further includes a second USB transceiver 320 to be electrically connected between the first USB transceiver 310 and the decoder 230 in order to receive the USB digital transport stream and convert it into the digital transport stream for sending to the decoder 230. The devices 310 and 320 are connected by insertion.

The mobile video systems 200 and 300 can be a handheld device, such as a personal digital assistant (PDA). The mobile video systems 200 and 300 can be implemented on a vehicle (not shown).

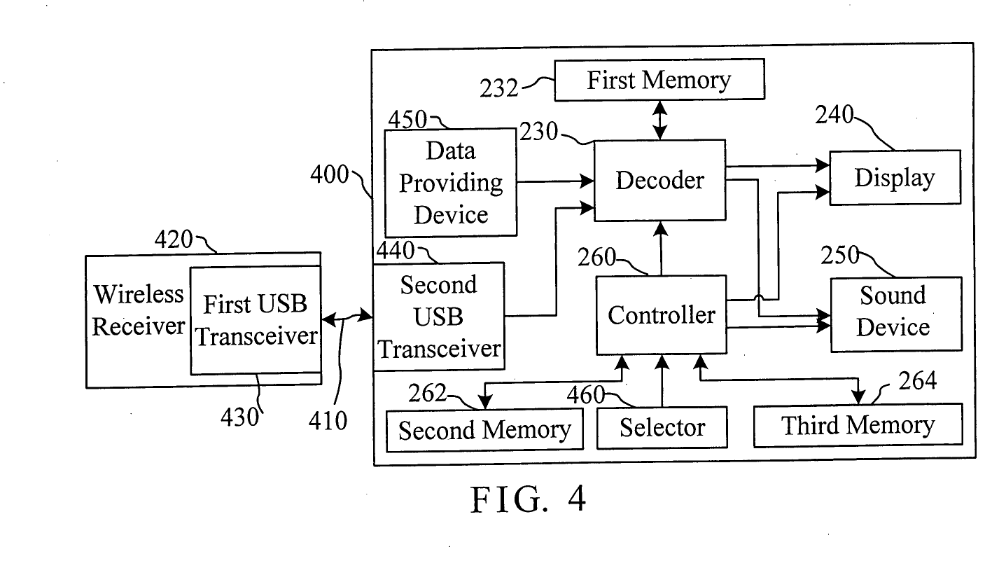

FIG. 4 is a block diagram of the mobile video system 400 in accordance with a further embodiment of the invention. In this embodiment, the system 400 adds a data providing device 450 and a selector 460. In addition, the system 400, as compared to the system 300 of FIG. 3, replaces the detachable wireless receiver 330 with the wireless receiver 420 which can be a PDA with an RF transceiver, or a cellphone implemented with a general packet radio service (GPRS), wideband code division multiple access (WCDMA) or CDMA2000 standard. The wireless receiver 420 includes a first USB transceiver 430 to convert the digital transport stream into a USB digital transport stream to output. In addition, the mobile video system 400 further includes a second USB transceiver 440 to be electrically connected to the decoder 230. The wireless receiver 420 can receive the digital transport stream in wireless transmission, and outputs the USB digital transport stream through the first USB transceiver 430. In this embodiment, the first USB transceiver 430 is connected by a USB cable 410 with the second USB transceiver 440. Accordingly, the USB digital transport stream can be sent from the first USB transceiver 430 to the second USB transceiver 440 through the USB cable 410.

The data providing device 450 provides a compressed video data stream. The data providing device 450 can be a VCD extractor to extract the compressed video data stream recorded in a VCD. In this case, the compressed video data stream is an MPEG1 compressed video data stream. The data providing device 450 can be a digital versatile disc (DVD) extractor to extract the compressed video data stream recorded in a DVD. In this case, the compressed video data stream is an MPEG2 compressed video data stream. In addition, the compressed video data stream can be an MPEG4 or H.264 compressed video data stream.

The selector 460 is implemented on a panel (not shown) of the mobile video system 400. The selector 460 is a dial in-line package (DIP) switch to produce a first selection signal corresponding to the compressed video data stream, and a second selection signal corresponding to the digital transport stream.

When the selector 460 produces the first selection signal corresponding to the compressed video data stream, the controller 260 accordingly drives the decoder 230 to decode the compressed video data stream. When the selector 460 produces the second selection signal corresponding to the digital transport stream, the controller 260 accordingly drives the decoder 230 to decode the digital transport stream to thus obtain the video data stream.

In view of the foregoing, it is known that the invention uses a wireless receiver 220 to receive video signal in wireless transmission and demodulate the video signal to thereby produce a digital transport stream. Accordingly, the real-time program can be played.

Although the present invention has been explained in relation to its preferred embodiment, it is to be understood that many other possible modifications and variations can be made without departing from the spirit and scope of the invention as hereinafter claimed.

What is claimed is:

1. A mobile video system, comprising:
a wireless receiver, which receives a wireless video signal in wireless transmission and demodulates the wireless video signal to thereby produce a digital transport stream;
a decoder, which is connected to the wireless receiver in order to receive and decode the digital transport stream to thereby produce a video data stream;
a sound device, which is connected to the decoder in order to receive a sound signal corresponding to the video data stream for playing;
a display, which is connected to the decoder in order to receive an image signal corresponding to the video data stream for playing; and
a controller, which is electrically connected to the wireless receiver, the decoder, the sound device and the display in order to perform initialization and operating mode settings on the wireless receiver, the decoder, the sound device and the display, and drive the decoder to decode the digital transport stream to thereby produce the video data stream.

2. The system as claimed in claim 1, wherein the wireless receiver is a detachable wireless receiver to receive and demodulate the wireless video signal to thereby produce the digital transport stream.

3. The system as claimed in claim 2, wherein the decoder, the sound device, the display and the controller are integrated into an embedded system.

4. The system as claimed in claim 3, wherein the wireless receiver is a detachable digital television (DTV) tuner to receive a wireless DTV signal in wireless transmission and modulate the wireless DTV signal to thereby produce the digital transport stream.

5. The system as claimed in claim 4, wherein the detachable DTV tuner comprises a first USB transceiver to convert the digital transport stream into a USB digital transport stream.

6. The system as claimed in claim 5, further comprising a second USB transceiver electrically connected between the decoder and the first USB transceiver in order to receive and convert the USB digital transport stream into the digital transport stream, and to output the digital transport stream to the decoder, and wherein the first USB transceiver is electrically connected by insertion to the second USB transceiver.

7. The system as claimed in claim 6, wherein the mobile video system is a personal digital assistant (PDA).

8. The system as claimed in claim 6, wherein the mobile video system is implemented on a vehicle.

9. The method as claimed in claim 1, further comprising:
a data providing device, which provides a compressed video data stream; and
a selector, which produces a first selection signal corresponding to the compressed video data stream, and a second selection signal corresponding to the digital transport stream;
wherein the controller drives the decoder to decode the compressed video data stream when the first selection signal is selected, and to decode the digital transport stream when the second selection signal is selected, thereby producing the video data stream.

10. The system as claimed in claim 9, wherein the data providing device is a video compact disk (VCD) extractor to extract the compressed video data stream recorded in a VCD.

11. The system as claimed in claim 9, wherein the data providing device is a digital versatile disc (DVD) extractor to extract the compressed video data stream recorded in a DVD.

12. The system as claimed in claim 2, wherein the detachable wireless receiver is a general packet radio service (GPRS) cellphone.

13. The system as claimed in claim 2, wherein, the detachable wireless receiver is a wideband code division multiple access (WCDMA) cellphone.

14. The system as claimed in claim 2, wherein the detachable wireless receiver is a code division multiple access 2000 (WCDMA2000) cellphone.
